(19) United States
(12) Patent Application Publication
(10) Pub. No.: US 2006/0015885 A1
(43) Pub. Date: Jan. 19, 2006

(54) Device for holding a disk cartridge in a disk recording/reproducing apparatus

(75) Inventors: Jeung-rak Lee, Suwon-si (KR); Young-bok Lee, Seoul (KR)

Correspondence Address: STAAS & HALSEY LLP, SUITE 700, 1201 NEW YORK AVENUE, N.W., WASHINGTON, DC, 20005, US

(73) Assignee: Samsung Electronics Co., Ltd., Suwon-si (KR)

(21) Appl. No.: 11/157,989

(22) Filed: Jun. 22, 2005

(30) Foreign Application Priority Data
Jul. 14, 2004 (KR) 2004-54682

(51) Int. Cl. G11B 33/02

(52) U.S. Cl. 720/600

(57) ABSTRACT

Disclosed is a disk recording/reproducing apparatus including: a body of the disk recording/reproducing apparatus; a disk tray mounted to be come in and out of the body, the disk tray including a seat unit in which a disk cartridge is safely seated; a cartridge holder movably mounted to the disk tray, to come in and out of the seat unit, the cartridge holder contacting and supporting the disk cartridge safely seated in the seat unit; an elastic member for pressing the cartridge holder to the seat unit; and a clamp mounted to operate in association with the disk tray when the cartridge is moved, the clamp clamping the disk cartridge safely seated in the seat unit.

### CROSS-REFERENCE TO RELATED APPLICATIONS

This application claims the benefit of Korean Patent Application No. 2004-54682, filed on Jul. 14, 2004, the entire content of which is incorporated herein by reference in its entirety.

### BACKGROUND OF THE INVENTION

1. Field of the Invention

The present invention relates to a disk recording/reproducing apparatus, and more particularly, to a device for holding a disk cartridge in the disk recording/reproducing apparatus

2. Description of the Related Art

In general, as a disk recording/reproducing apparatus, there is a CD-ROM driver, a video disk apparatus, a digital audio disk apparatus, a DVD player, and others.

Such a disk recording/reproducing apparatus includes a disk tray for loading a disk, which is mounted to come in and out of a machine body; a turn table in which a loaded disk is safely seated; a chucking unit for chucking the disk seated in the turn table; a spindle motor for revolving the disk and the turn table together; and an optical pickup for recording and reproducing information on and from the disk as revolved.

In the structure described above, the disk tray is ordinarily provided with a seat unit in which a disk of 120 mm or 80 mm is safely seated. The seat unit is designed to directly and safely seat a low-capacity disk, which is relatively less affected by any alien substance or scratch because ordinary recording capacity is low.

Recently, however, the recording capacity of a disk has increased and high-density optical disks such as blue ray disks are available. As a high-density optical disk is sensitive to alien substances, scratches or a user's fingerprints, it has to be kept in an additional disk cartridge for use. Therefore, the disk tray is provided with a seat unit in which the disk cartridge is safely seated, and a holding device for holding the disk cartridge in the disk tray is required.

As an example of a device for holding a disk cartridge, a tension unit by molding is provided at the cover of the machine body such that the disk tray inserted into the machine body is elastically supported in the upper part of the disk cartridge. That is, in such a structure, the disk cartridge is fixed by using the frictional force of the tension unit.

However, such a conventional structure has the problem that dust is generated by friction between the disk cartridge and the tension unit and load is increased due to the friction.

### SUMMARY OF THE INVENTION

Additional aspects and/or advantages of the invention will be set forth in part in the description which follows and, in part, will be apparent from the description, or may be learned by practice of the invention.

An aspect of the invention is to solve the foregoing problems by providing a device for holding a disk cartridge in a disk recording/reproducing apparatus, which makes it possible to easily hold a disk cartridge safely seated in a disk tray.

The above aspect is achieved by providing a device for holding a disk cartridge in a disk recording/reproducing apparatus, including a disk tray that includes a seat unit in which a disk cartridge is safely seated, the disk tray mounted to come in and out of the body of a disk recording/reproducing apparatus; a cartridge holder for contacting and supporting the disk cartridge as safely seated in the seat unit, the cartridge holder movably mounted to the disk tray, to come in and out of the seat unit, the cartridge holder contacting and supporting the disk cartridge safely seated in the seat unit; and a clamp for clamping the disk cartridge when safely seated in the seat unit, the clamp mounted to operate in association with the disk tray when the cartridge holder is moved.

The clamp may include a pivoting member mounted to be pivotal about the cartridge holder, and when the pivoting member moves with the cartridge holder, one end of the pivoting member pivots, in association with the disk tray, and the other end clamps the disk cartridge seated in the seat unit.

The disk tray may include a slope positioned to be in contact and in association with one end of the pivoting member.

The center of the pivoting member may be inclined toward the other end for clamping the disk cartridge.

The pivoting member may be provided, in pairs, to be parallel to the direction in which the disk tray comes in and out.

A hole through which the other end of the pivoting member is exposed may be formed at the upper part of the disk holder such that the other end of the pivoting member clamps the upper part of the disk cartridge when safely seated in the seat unit.

Another aspect of the invention is achieved by providing a disk recording/reproducing apparatus including a body of the disk recording/reproducing apparatus; a disk tray including a seat unit in which a disk cartridge is safely seated, the disk tray mounted to come in and out of the body; a cartridge holder for contacting and supporting the disk cartridge seated in the seat unit, the cartridge holder mounted to come in and out of the seat unit so as to be movable in the disk tray; an elastic member for pressing the cartridge holder toward the seat unit; and a clamp for clamping the disk cartridge seated in the seat unit, the clamp mounted to operate in association with the disk tray when the cartridge holder is moved.

### BRIEF DESCRIPTION OF THE DRAWINGS

The above aspects and features of the present invention will become apparent by describing certain embodiments of the present invention with reference to the accompanying drawings, in which:

FIG. 1 is a schematic side sectional view illustrating a device for holding a disk cartridge in a disk recording/reproducing apparatus according to an embodiment of the present invention;

FIG. 2 is a perspective view illustrating the device for holding a disk cartridge as shown in FIG. 1;

FIG. 3 is a sectional view of essential parts of FIG. 1;

FIG. 4 is a side sectional view illustrating a disk cartridge clamped in the disk recording/reproducing apparatus; and

FIG. 5 is an enlarged sectional view illustrating the essential parts of FIG. 4.

### DETAILED DESCRIPTION OF THE PREFERRED EMBODIMENTS

Reference will now be made in detail to the embodiments of the present invention, examples of which are illustrated in the accompanying drawings, wherein like reference numerals refer to the like elements throughout. The embodiments are described below to explain the present invention by referring to the figures.

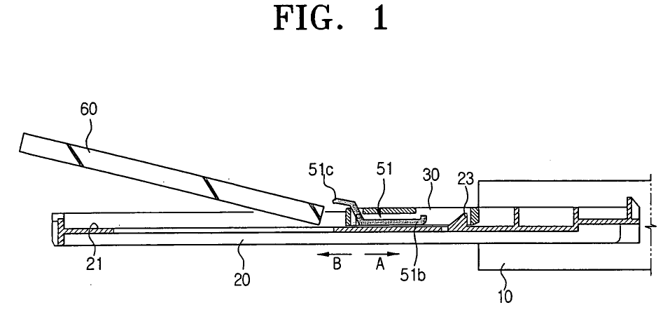

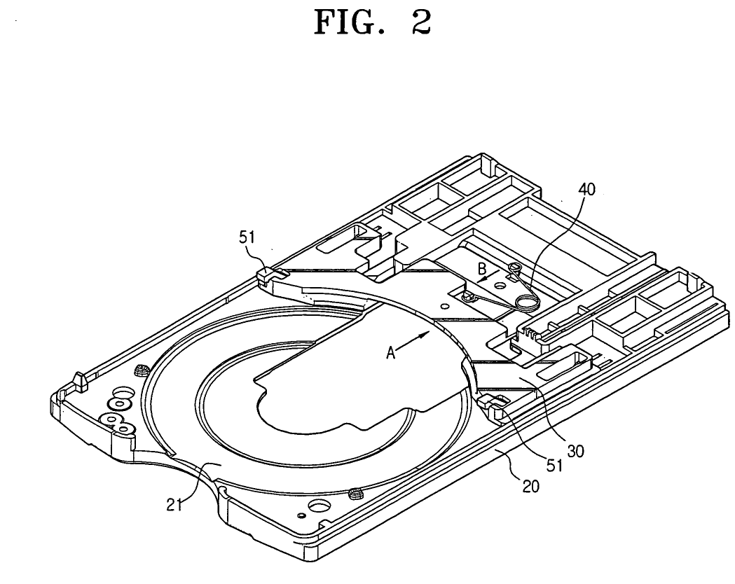

Referring to FIGS. 1 and 2, a device for holding a disk cartridge in a disk recording/reproducing apparatus according to an embodiment of the present invention includes a disk tray 20 to come in and out of a machine body 10; a cartridge holder 30 movably mounted on the disk tray 20; an elastic member 40 for pressing the cartridge holder 30 in an unloading direction B; and a clamp for clamping the disk cartridge 60 when seated in the disk tray 20. In one embodiment of the present invention, the clamp includes a pair of pivoting members 51 pivotally mounted on the cartridge holder 30.

The machine body 10 of the disk recording/reproducing apparatus is provided with an optical pickup, a spindle motor, a turntable and a disk chucking unit inside. The explanation of these constitutional elements is omitted in the detailed description of the preferred embodiments since these elements are known to those killed in the art.

The disk tray 20 is movably mounted on the machine body 10 in a loading direction (A) or an unloading direction (B) by a loading/unloading unit. The disk tray 20 is provided with a cartridge seat unit 21 in a predetermined shape, in which the disk cartridge 60 is safely seated.

The disk cartridge 60 in which the disk is received to safely seat in the seat unit 21 is inserted into the machine body 10. The disk cartridge 60 varies with respect to shape and size, and the structure of the disk cartridge also varies accordingly. Therefore, the explanation of the structure of the disk cartridge is omitted here.

The cartridge holder 30 is slidably mounted on the disk tray 20. Specifically, the cartridge holder 30 is mounted to come in and out of the seat unit 21. Therefore, the cartridge holder 30 is pushed to move in the loading direction (A) by the front end of the disk cartridge 60 as seated in the seat unit 21.

The elastic member 40 may be a torsion spring mounted on the disk tray 20 for pressing the cartridge holder 30 in the unloading direction (B). As the elastic member 40 presses the cartridge holder 30 in the unloading direction (B), the cartridge holder 30 contacts and presses the disk cartridge 60 when seated in the seat unit 21 such that the movement in the loading/unloading direction (A, B) is fixed.

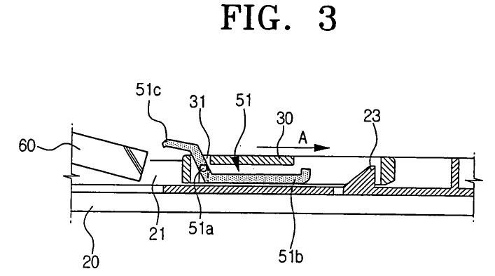

The pivoting members 51 are provided to be spaced at a predetermined distance and to be parallel to the direction (A, B) in which the disk tray 20 is loaded/unloaded. Each pivoting member 51 is mounted to be upwardly or downwardly pivoted about a pivot shaft 51a as shown in FIG. 3. One end 51b of the pivoting member 51 is positioned between the cartridge holder 30 and the disk tray 20, and the other end 51c is positioned on the upper part of the seat unit 21 to be exposed on the upper side of the cartridge holder 30. The cartridge holder 30 is provided with a hole 31 through which the other end 51c of the pivoting member 51 is exposed. The pivot shaft 51a of the pivoting member 51 declines toward the other end 51c. Therefore, the one end 51b of the pivoting member 51 is maintained in place on the upper side of the disk tray 20 by its own weight. As the other end 51c of the pivoting member 51 is maintained in the state of being upwardly raised in the seat unit 21, the disk cartridge 60 is safely seated in the seat unit 21 without any interference.

The disk tray 20 has a slope 23 formed therein for pivoting the pivoting member 51. If the cartridge holder 30 is moved in the loading direction (A), the pivoting member 51 is also moved. One end 51b of the pivoting member 51 contacts the slope 23 and is upwardly guided and pivoted. Accordingly, the other end 51c of the pivoting member 51 is downwardly lowered so that it presses the upper side of the disk cartridge 60 placed in the seat unit 21 and clamps the disk cartridge 60 in place. Thereby, the disk cartridge 60 is fixed in upward and horizontal directions.

The device for holding a disk cartridge in a disk recording/reproducing apparatus according to the embodiment of the present invention having the structure described above is explained in detail with respect to the effects acting on the disk cartridge 60 below.

To mount the disk cartridge 60, the disk tray 20 is taken out of the body 10 as shown in FIG. 1. In this state, the cartridge holder 30 is pushed by the elastic member 40 toward the unloading direction (B).

The disk cartridge 60 is placed in an inclined attitude on the seat unit 21 as shown in FIG. 1. The cartridge holder 30 inclining toward the seat unit 21 is pushed by the disk cartridge 60 as seated in the seat unit 21 to move in the loading direction (A). The front end of the disk cartridge 60 is positioned on the lower side of the other end 51c of the pivoting member 51 as shown in FIG. 3.

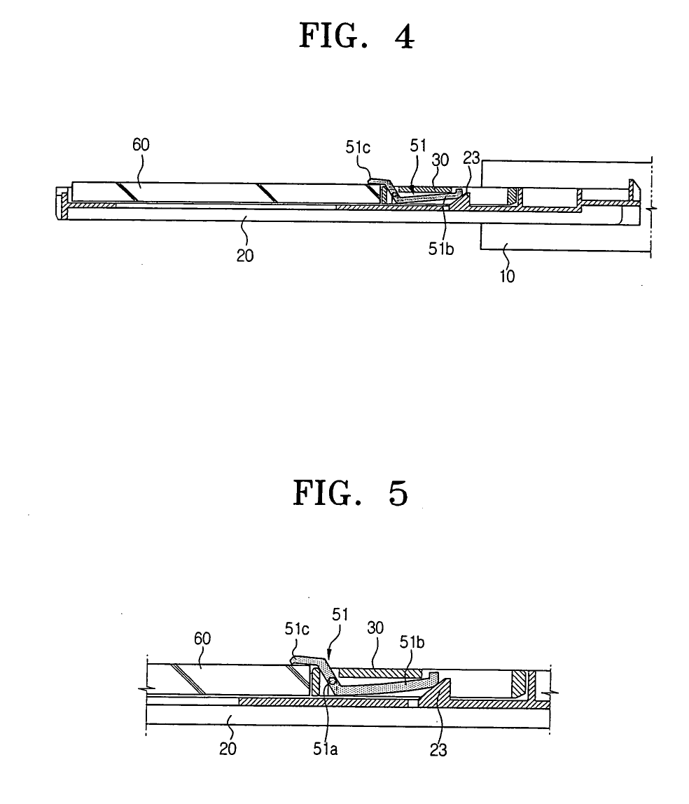

As shown in FIG. 4, if the disk cartridge 60 is completely and safely seated in the seat unit 21, the disk cartridge 60 is completely pushed in the loading direction (A) by the disk cartridge 60. Then, one end 51b of each of the pivoting members 51 is guided to the slope 23 such that the pivoting member 51 is pivoted counterclockwise. Therefore, the other end 51c of the pivoting member 51 as pivoted presses the upper side of the disk cartridge 60 to clamp the disk cartridge 60 as illustrated in detail in FIG. 5.

The pivoting member 51 is of molded construction using quality plastic materials, in which one end 51b has elasticity to a certain extent. Therefore, elasticity is generated to a certain extent at one end 51b guided to the slope 23. The elastic force as generated at one end 51b acts upon the other end 51c such that the other end 51c elastically presses the upper side of the disk cartridge 60 to be clamped.

As described above, the disk cartridge 60 is seated in the seat unit 21 and concurrently clamped by the pivoting member 51 so that it is loaded into the body 10 in a stable state. This is different from the conventional art, as the disk cartridge 60 is in the clamped state by the pivoting member 51, it is not necessary to additionally mount an additional fixing member on the body 10. Therefore, there are advantages in that it is possible to prevent dust from being generated by friction and load being increased as a result of the friction.

If the disk cartridge 60 is separated from the seat unit 21, the cartridge holder 30 moves in the unloading direction (B) by the elastic member 40 to its original position. Then, the pivoting member 51 is separated from the slope 23. As one end 51b is longer than the other end 51c, the pivoting member 51 is biased towards the one end 51 b. As the pivoting member 51 is rotated clockwise to its original position by gravity, the other end 51c is separated from the disk cartridge 60 and is provided with a space where the front end of the disk cartridge 60 is inserted.

As described above, according to the present invention a device for holding a disk cartridge in a disk recording/reproducing apparatus is provided where the disk cartridge is held at the point of time when the disk cartridge is safely seated in the disk tray.

Therefore, when loading the disk tray, it is not necessary to hold the disk cartridge by frictional contact as in the conventional art.

Consequently, it is possible to improve the quality of the machine since it is possible to prevent dust from being generated by friction.

Further, it is possible to improve the reliability of the product by performing a stable loading/unloading operation since it is possible to prevent the load by friction from being increased.

Although a few embodiments of the present invention have been shown and described, it would be appreciated by those skilled in the art that changes may be made in these embodiments without departing from the principles and spirit of the invention, the scope of which is defined in the claims and their equivalents.

What is claimed is:

1. A device for holding a disk cartridge in a disk recording/reproducing apparatus comprising:
a disk tray mounted to come in and out of a body of the disk recording/reproducing apparatus, the disk tray including a seat unit in which a disk cartridge is safely seated;
a cartridge holder movably mounted to the disk tray, to come in and out of the seat unit, the cartridge holder contacting and supporting the disk cartridge safely seated in the seat unit;
an elastic member for pressing the cartridge holder to the seat unit; and
a clamp mounted to operate in association with the disk tray when the cartridge holder is moved, the clamp clamping the disk cartridge safely seated in the seat unit.

2. The device for holding a disk cartridge as claimed in claim 1, wherein the clamp comprises a pivoting member mounted to be pivotal around the cartridge holder, and the pivoting member comprises one end pivoting in association with the disk tray and an other end for clamping the disk cartridge safely seated in the seat unit when moving along with the cartridge holder.

3. The device for holding a disk cartridge as claimed in claim 2, wherein the disk tray includes a slope positioned to be in contact and in association with the one end of the pivoting member.

4. The device for holding a disk cartridge as claimed in claim 2, wherein the center of the pivoting member is inclined to the other end for clamping the disk cartridge.

5. The device for holding a disk cartridge as claimed in claim 2, wherein the pivoting member is provided in pairs to be parallel to the direction in which the disk tray comes in and out.

6. The device for holding a disk cartridge as claimed in claim 5 wherein the disk holder forms, on its upper side, a hole through which the other end of the pivoting member is exposed such that the other end of the pivoting member clamps the upper side of the disk cartridge safely seated in the seat unit.

7. The device for holding a disk cartridge as claimed in claim 2, wherein the pivoting member is made of plastic materials.

8. The device for holding a disk cartridge as claimed in claim 2, wherein the pivoting member is made of materials having elasticity.

9. The device for holding a disk cartridge as claimed in claim 3, wherein the pivoting member contacts and supports the disk cartridge by the elastic force as elastically changed in contact with the slope.

10. The device for holding a disk cartridge as claimed in claim 1, wherein the elastic member is a torsion spring.

11. A disk recording/reproducing apparatus comprising:
a body of the disk recording/reproducing apparatus;
a disk tray mounted to come in and out of the body, the disk tray including a seat unit in which a disk cartridge is safely seated;
a cartridge holder movably mounted to the disk tray, to come in and out of the seat unit, the cartridge holder contacting and supporting the disk cartridge safely seated in the seat unit;
an elastic member for pressing the cartridge holder to the seat unit; and
a clamp mounted to operate in association with the disk tray when the cartridge holder is moved, the clamp clamping the disk cartridge safely seated in the seat unit.

12. The device for holding a disk cartridge as claimed in claim 11, wherein the clamp includes a pivoting member pivotally mounted in the cartridge holder, the pivoting member having one end operating in association with the disk tray to be rotated and an other end clamping the disk cartridge safely seated in the seat unit when the cartridge is moved.

13. The disk recording/reproducing apparatus as claimed in claim 12, wherein the disk tray includes a slope positioned to be in contact and in association with one end of the pivoting member.

14. The disk recording/reproducing apparatus as claimed in claim 12, wherein the center of the pivoting member is inclined to the other end clamping the disk cartridge.

15. The disk recording/reproducing apparatus as claimed in claim 12, wherein the pivoting member is in pairs to be parallel to the direction in which the disk tray comes in and out.

16. The disk recording/reproducing apparatus as claimed in claim 14, wherein the disk holder includes, on its upper side, a hole through which the other end of the pivoting member is exposed so that the other end of the pivoting member clamps the upper side of the disk cartridge safely seated in the seat unit.

17. The disk recording/reproducing apparatus as claimed in claim 12, wherein the clamp is constructed from plastic.

18. The disk recording/reproducing apparatus as claimed in claim 12, wherein the clamp is constructed from materials having elasticity.

19. The disk recording/reproducing apparatus as claimed in claim 13, wherein the other end of the pivoting member contacts and supports the disk cartridge when the one end of the pivoting member comes in contact with the slope.

20. The disk recording/reproducing apparatus as claimed in claim 11, wherein the elastic member is a torsion spring.
